(19) United States
(12) Patent Application Publication
(10) Pub. No.: US 2019/0278486 A1
(43) Pub. Date: Sep. 12, 2019

(54) STORAGE SYSTEM, DATA MANAGEMENT METHOD, AND DATA MANAGEMENT PROGRAM

(71) Applicant: HITACHI, LTD., Tokyo (JP)

(72) Inventors: Takahiro Naruko, Tokyo (JP); Masahiro Tsuruya, Tokyo (JP); Akifumi Suzuki, Tokyo (JP); Shimpei Nomura, Tokyo (JP)

(73) Assignee: HITACHI, LTD., Tokyo (JP)

(21) Appl. No.: 16/052,861

(22) Filed: Aug. 2, 2018

(30) Foreign Application Priority Data
Mar. 12, 2018 (JP) 2018-043950

(51) Int. Cl. G06F 3/06; G06F 12/02

(52) U.S. Cl. CPC G06F 3/0611; G06F 3/0616; G06F 3/0631; G06F 2212/2022; G06F 3/0653; G06F 12/0246; G06F 2212/1024; G06F 3/0679

(57) ABSTRACT

In a storage system capable of making connection to one or more SSDs and capable of controlling inputting and outputting of data to and from a storage region of the SSD, the storage system includes a processor that executes a process. The processor is configured to manage a part of a storage region provided by the one or more SSDs with the same characteristics as a first storage region (performance maintenance region) used to store predetermined data, determine data to be stored in the first storage region in data of which a write access frequency is less than a predetermined value, store the data in the first storage region, and store data determined not to be stored in the first storage region in a second storage region (a normal region) which is different from the first storage region and is provided by the one or SSDs with the same characteristics.

### CROSS REFERENCE TO PRIOR APPLICATIONS

This application claims benefit of priority to Japanese Patent Application No. 2018-043950, filed on Mar. 12, 2018. The entire content of the above application is hereby incorporated by reference.

### BACKGROUND OF THE INVENTION

### Field of the Invention

The present invention relates to a storage system that manages data using a storage region of a nonvolatile semiconductor memory device.

### Background Art

For example, flash memories are known as nonvolatile semiconductor memories included in nonvolatile semiconductor memory devices. Flash memories have characteristics (maintenance characteristics) in which the number of inverted bits (failure bits) increases in stored data in accordance with elapsed times after writing of data. Further, flash memories have characteristics (deterioration in data maintenance characteristics) in which an increase in the number of failure bits accelerates with the number of erasing processes (the number of erasures). Therefore, in storage devices using flash memories as storage mediums, for example, in solid state drives (SSDs), error correcting codes (ECCs) having error code correcting capabilities of a plurality of bits are added to stored data to be stored and failure bits are corrected using the ECCs at the time of reading data.

However, when a long time has passed from writing of data, when data maintenance characteristics of an SSD deteriorate, or when such events are combined, the number of failure bits exceeding the number of bits which can be corrected by an ECC occurs. Thus, in an SSD, a scheme of correcting failure bits and reading data is used by using a scheme (a rereading scheme) of reading input data while minutely adjusting parameters of a flash memory or a strong error code correcting algorithm.

In an SSD of which data maintenance characteristics deteriorate due to the many number of erasures, failure bits increase rapidly. Therefore, data of which the number of failure bits exceeds the number of correctable bits by an ECC increases. It is necessary to read the data using a rereading scheme or a strong error code correcting algorithm. However, when the rereading scheme or the strong error code correcting algorithm is used, a long processing time is necessary. Therefore, in order to read data of which the number of failure bits increases, a large delay time is necessary. Due to the foregoing reasons, an average read latency of an SSD deteriorates with the quantity of data written on the SSD.

For example, U.S. Pat. No. 7,325,090 discloses a technology (refresh) for temporarily reading data at a predetermined interval after data is recorded on a flash memory and rewriting the data on the flash memory again.

### SUMMARY OF THE INVENTION

For example, a case in which there is no countermeasure against deterioration in an average read latency in a flash memory will be described. In this case, data of which a write frequency is high can be read at a constant delay time without depending on a data write quantity on an SSD. This is because for the data of which the write frequency is high, a time elapsed from writing is short and the number of failure bits remains equal to or less than the number of correctable bits by an ECC. On the other hand, for data of which a write frequency is low, a delay time increases with an increase in a data write quantity on an SSD. Therefore, the average read latency of the SSD deteriorates with the increase in the data write quantity on the SSD.

Next, a case in which refresh (high-frequency refresh) is executed at an interval shorter than an interval at which data is lost in order to improve an average read latency in a flash memory will be described. In the case in which the high-frequency refresh is executed, stored data is overwritten through refresh before the number of failure bits of the data exceeds the number of correctable bits by an ECC. Therefore, for data in which a write frequency is low in addition to data in which a write frequency is high, a read latency can be maintained constantly without depending on a data write quantity on an SSD. However, when the high-frequency refresh is executed, it is necessary to regenerate data frequently in a flash memory. Since a quantity data which can be written on a flash memory (rewrite resistance) is finite, the high-frequency refresh may reduce a quantity of data (lifetime) which can be written on an SSD by a high-order device.

For example, rewrite resistance of a current triple level cell (TLC) flash memory is expected to be lower than a quad level cell (QLC) flash memory which is expected to be spread in the future. Therefore, when the high-frequency refresh is used, there is a concern that a lifetime of an SSD in which a data write quantity by a user is sufficient is not provided.

The invention is devised in the foregoing circumstances and an object of the invention is to provide a technology capable of maintaining a low average read latency of data in a storage system capable of making connection to a nonvolatile semiconductor memory device.

To achieve the foregoing object, according to an aspect of the invention, a storage system is capable of making connection to one or more nonvolatile semiconductor memory devices and is capable of controlling inputting and outputting of data to and from a storage region of the nonvolatile semiconductor memory device. The storage system includes a processor that executes a process. The processor manages a part of a storage region provided by the one or more nonvolatile semiconductor memory devices with the same characteristics as a first storage region used to store predetermined data. The processor determines data to be stored in the first storage region in data of which a write access frequency is less than a predetermined value, stores the data in the first storage region. The processor stores data determined not to be stored in the first storage region in a second storage region which is different from the first storage region and is provided by the one or more nonvolatile semiconductor memory devices with the same characteristics.

According to the invention, it is possible to maintain a low average read latency in a storage system capable of connecting a nonvolatile semiconductor memory device.

### BRIEF DESCRIPTION OF THE DRAWINGS

FIG. 1 is a diagram illustrating an overall configuration of a computer system according to a first embodiment.

FIG. 2 is a diagram illustrating a configuration of a RAM of a storage controller according to the first embodiment.

FIG. 3 is a diagram illustrating a logical configuration of a volume according to the first embodiment.

FIG. 4 is a diagram illustrating an example of a management screen according to the first embodiment.

FIG. 5 is a diagram illustrating a configuration of a connection device management table according to the first embodiment.

FIG. 6 is a diagram illustrating a configuration of an access frequency management table according to the first embodiment.

FIG. 7 is a diagram illustrating a configuration of a virtual address conversion table according to the first embodiment.

FIG. 8 is a diagram illustrating a configuration of an empty physical address management queue according to the first embodiment.

FIG. 9 is a flowchart illustrating an initial setting process according to the first embodiment.

FIG. 10 is a flowchart illustrating a region capacity calculation process according to the first embodiment.

FIG. 11 is a flowchart illustrating a read process according to the first embodiment.

FIG. 12 is a flowchart illustrating a write process according to the first embodiment.

FIG. 13 is a flowchart illustrating an access frequency update process according to the first embodiment.

FIG. 14 is a flowchart illustrating a migration process according to the first embodiment.

FIG. 15 is a flowchart illustrating a location region determination process according to the first embodiment.

FIG. 16 is a flowchart illustrating a page migration process according to the first embodiment.

FIG. 17 is a diagram illustrating an overall configuration of a computer system according to a second embodiment.

FIG. 18 is a diagram illustrating a configuration of an SSD according to the second embodiment.

FIG. 19 is a flowchart illustrating an initial setting process according to the second embodiment.

### DETAILED DESCRIPTION OF THE INVENTION

Several embodiments will be described with reference to the drawings. The embodiments to be described below do not limit the invention in the claims. All the elements to be described in the embodiments and combinations of the elements are not all requisite for solutions to the invention.

In the following description, information is described in an expression “AAA table” in some cases, but information may be expressed with any data structure. That is, in order to indicate that information does not depend on a data structure, “AAA table” can be said to be “AAA information”.

In the following description, a “processor” includes one or more processors. At least one processor is generally a microprocessor such as a central processing unit (CPU). Each of the one or more processors may be a single core or a multi-core. The processor may include a hardware circuit that executes some or all of the processes.

In the following description, a “program” is used as a main entity of an operation to describe a process in some cases. However, since a program is executed by a processor (for example, a central processing unit (CPU)) and a given process is executed appropriately using a storage unit (for example, a memory) and/or an interface device (for example, a communication port), a main entity for a process may be considered as a processor (or a device or a system including the processor). The processor may include a hardware circuit that executes some or all of the processes. A program may be installed in a device such as a computer from a program source. The program source may be, for example, a nonvolatile storage medium from which data can be read by a program server or a computer. In the following description, two or more programs may be realized as one program or one program may be realized as two or more programs.

First, a computer system according to the first embodiment will be described.

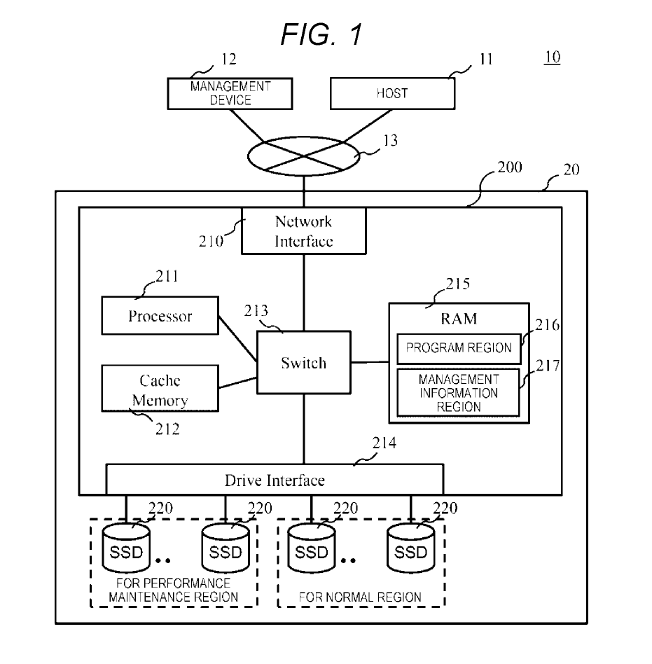

FIG. 1 is a diagram illustrating an overall configuration of a computer system according to a first embodiment.

A computer system 10 includes a host computer (hereinafter referred to as a host) 11, a management device 12, and a storage system 20. The host 11, the management device 12, and the storage system 20 are connected to each other, for example, via a network 13 such as a local area network (LAN) or a wide area network (WAN).

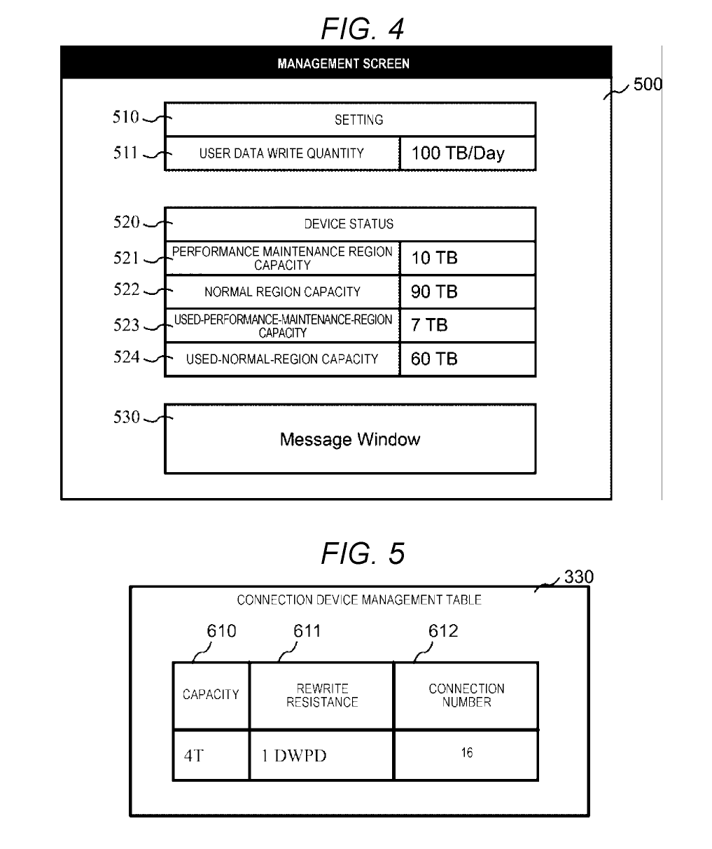

The host 11 is a device that includes, for example, a file system and a computer which are cores of a business system and requests the storage system 20 to execute read/write. The management device 12 is a computer that includes, for example, hardware resources such as a processor, a memory, a network interface, a local input and output device and software resources such as a management program. The management device 12 acquires information from the storage system 20 using the management program and displays, for example, a management screen 500 (see FIG. 4) via a local input and output device (a display or the like). The management device 12 has a function of responding with various types of setting information input by a system manager through the management screen 500 in response to a request from the storage system 20. The storage system 20, the host 11, and the management device 12 may be configured with the same hardware device or may be configured with different hardware devices.

The storage system 20 includes a storage controller 200 and solid state drives (SSD) 220 which are examples of one or more nonvolatile semiconductor memory devices.

The storage controller 200 includes a network interface 210, a processor 211 which is an example of a processor, a cache memory 212, a drive interface 214, a random access memory (RAM) 215 which is an example of a memory unit, and a switch 213 connecting the elements to each other.

The processor 211 controls the whole storage system 20 based on a program or management information stored in the RAM 215. The RAM 215 includes a program region 216 that stores a program to be executed by the processor 211 and a management information region 217 that stores various types of management information.

The cache memory 212 maintains write target data transmitted from the host 11 until the write target data is written on the SSD 220. The cache memory 212 maintains the write target data read from the SSD 220 until the write target data is transmitted to the host 11 in response to a read request from the host 11. The drive interface 214 is an interface that connects the storage controller 200 to one or more SSDs 220 so that communication is possible. The network interface 210 is an interface that makes connection to an external device (the host 11, the management device 12, or the like) via the network 13 so that communication is possible.

The network interface 210, the processor 211, the cache memory 212, the drive interface 214, the RAM 215, and the switch 213 may be configured as one semiconductor element such as an application specific integrated circuit (ASIC) or a field programmable gate array (FPGA) or may be configured by connecting a plurality of individual integrated circuits (ICs) to each other.

In the embodiment, the plurality of SSDs 220 are SSDs that have the same characteristics (at least, the same memory cell configuration) and may have the same capacity and the same rewrite resistance. The SSDs 220 have the same memory cell configuration (for example, one of QLC and TLC) and different capacities. In the embodiment, in order to maintain a low average read latency in the storage system 20, the storage controller 200 allocates each storage region to one of the performance maintenance region (a first storage region) and a normal region (a second storage region) in units of the SSD 220 for management.

Next, a configuration of the RAM 215 of the storage controller 200 will be described in detail.

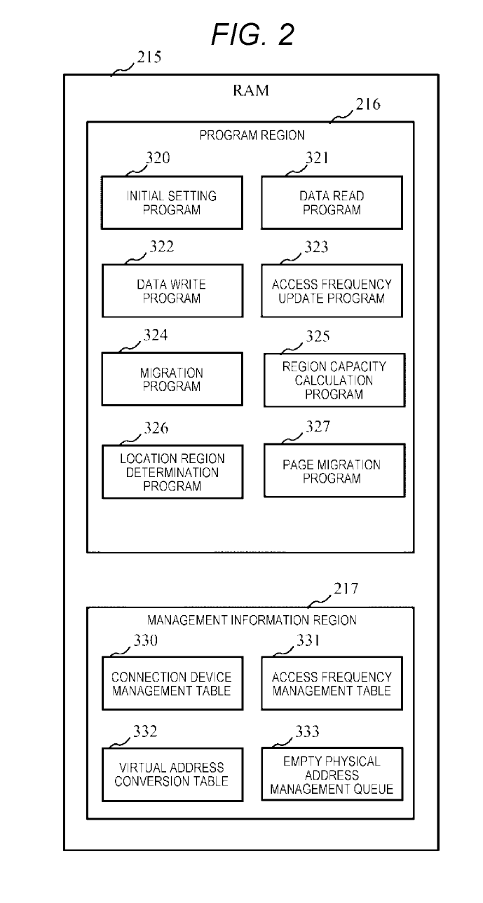

FIG. 2 is a diagram illustrating a configuration of a RAM of a storage controller according to the first embodiment.

The RAM 215 includes a program region 216 that stores programs executed by the processor 211 and a management information region 217 that stores various types of management information read and written by the programs.

The program region 216 stores an initial setting program 320, a data read program 321, a data write program 322, an access frequency update program 323, a migration program 324, a region capacity calculation program 325, a location region determination program 326, and a page migration program 327.

The initial setting program 320 is a program that calculates device parameters, constructs an RAID group, and initializes management information. The data read program 321 is a program that executes a process of reading data from the SSD 220 in response to a read request from the host 11 and responding to the host 11. The data write program 322 is a program that executes a process of writing write data corresponding to a write request from the host 11 on the SSD 220. The access frequency update program 323 is a program that calculates a data read frequency and a data write frequency. The migration program 324 is a program that relocates data in the SSD 220 based on the data read frequency and the data write frequency. The region capacity calculation program 325 is a program that calculates a capacity of the performance maintenance region and a capacity of the normal region. The location region determination program 326 is a program that determines regions of physical pages allocated to the logical pages. The page migration program 327 is a program that executes migration of data of the logical page.

The management information region 321 stores a connection device management table 330, an access frequency management table 331, a virtual address conversion table 332, and an empty physical address management queue 333.

The connection device management table 330 stores a capacity of the SSD 220 connected to the storage controller 200 or information such as rewrite resistance. The access frequency management table 331 manages the read frequency and the write frequency of each logical page of a volume. The virtual address conversion table 332 stores conversion information of the logical address and the physical address in the volume. The empty physical address management queue 333 manages an address of an unused region of the SSD 220.

Next, a logical configuration of the volume managed in the storage system 20 will be described.

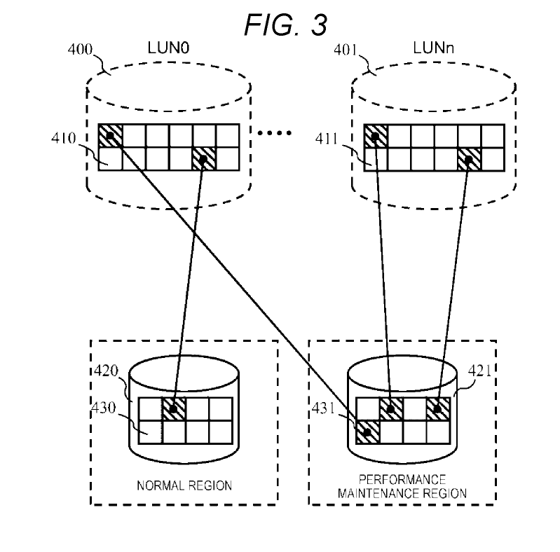

FIG. 3 is a diagram illustrating a logical configuration of a volume according to the first embodiment.

In the storage system 20, one or more logical volumes (LVOLs) 400 and 401 are managed. The logical volumes 400 and 401 are volumes that have logical storage regions which can be recognized from the host 11 and are targets of a write request and a read request by the host 11. Identifiable logical unit numbers (LUNs) can be assigned to the LVOLs 400 and 401. In the storage system 20, a logical storage region of the logical volume 400 (401) is partitioned into logical pages 410 (411) with a predetermined fixed length for management.

In the storage system 20, an RAID group 420 including the plurality of SSDs 220 allocated to the normal region and an RAID group 421 including the plurality of SSDs 220 allocated to the performance maintenance region are configured. In the RAID groups 420 and 421, the physical storage regions are partitioned into the physical pages 430 and 431 with the same size as the logical pages.

In the embodiment, when a write request is received with regard to a certain logical page from the host 11 for the first time, the storage system 20 dynamically allocates the physical page 430 of the RAID group 420 allocated to the normal region to the logical page, to the logical page. In the embodiment, the physical pages allocated to the logical pages 410 and 411 are changed through a migration process to be described below in some cases.

Next, the management screen 500 displayed for a system manager by the management device 12 will be described.

FIG. 4 is a diagram illustrating an example of a management screen according to the first embodiment.

On the management screen 500, a setting table 510, a device status table 520, and a message window 530 are displayed.

The setting table 510 is a table to which a parameter used to adjust an operation of the storage system 20 by the system manager is input. The setting table 510 includes a user data write quantity field 511. The user data write quantity field 511 is a region in which an assumed write quantity (user data write quantity) of a workload applied to the storage system 20 is designated by allowing the user to use the host 11. A unit of a write quantity may be a quantity of data per predetermined time. For example, terabytes (TB)/day may be used, a drive write per day (DWPD) may be used, or another unit such as total bytes written (TBW) may be used. When the assumed write quantity is designated in the user data write quantity field 511 by the system manager, the management device 12 notifies the storage system 20 of the designated assumed write quantity. A timing at which the storage system 20 is notified of the assumed write quantity may be a designated time point or a case in which a request is made from the storage system 20.

The device status table 520 is a table used to display a current state of the storage system 20. For example, the device status table 520 is displayed based on information transmitted from the storage system 20. The device status table 520 includes a performance maintenance region capacity field 521, a normal region capacity field 522, a used-performance-maintenance-region capacity field 523, and a used-normal-region capacity field 524.

In the performance maintenance region capacity field 521, a physical capacity of the SSD 220 allocated to the performance maintenance region is displayed. In the normal region capacity field 522, a physical capacity of the SSD 220 allocated to the normal region is displayed. In the used-performance-maintenance-region capacity field 523, a sum capacity of the data stored in the performance maintenance region is displayed. In the used-normal-region capacity field 524, a sum capacity of the data stored in the normal region is displayed. The capacities displayed in these fields may be another expression such as percentages of a use ratio in addition or instead of the TB unit.

Various types of messages are displayed on the message window 530.

Next, management information managed by the storage controller 200 will be described in detail.

First, the connection device management table 330 will be described.

FIG. 5 is a diagram illustrating a configuration of the connection device management table according to the first embodiment.

The connection device management table 330 is a table used to manage the state of the SSD 220 connected to the storage controller 200 and a 1-dimensional table that includes a capacity field 610, a rewrite resistance field 611, and a connection number field 612.

In the capacity field 610, a physical capacity per SSD 220 connected to the storage controller 200 is stored. In the rewrite resistance field 611, rewrite resistance information regarding a quantity of data which can be written per SSD 220 is stored. The rewrite resistance information may be a unit such as DWPD or TBW. In the connection number field 612, the number of SSDs 220 connected to the storage controller 200 is stored. For example, the information stored in the connection device management table 330 may be acquired from the SSD 220 that has an interface capable of responding with a capacity and rewrite resistance or may be acquired from the management device 12 to which information is input by the system manager.

Next, the access frequency management table 331 will be described.

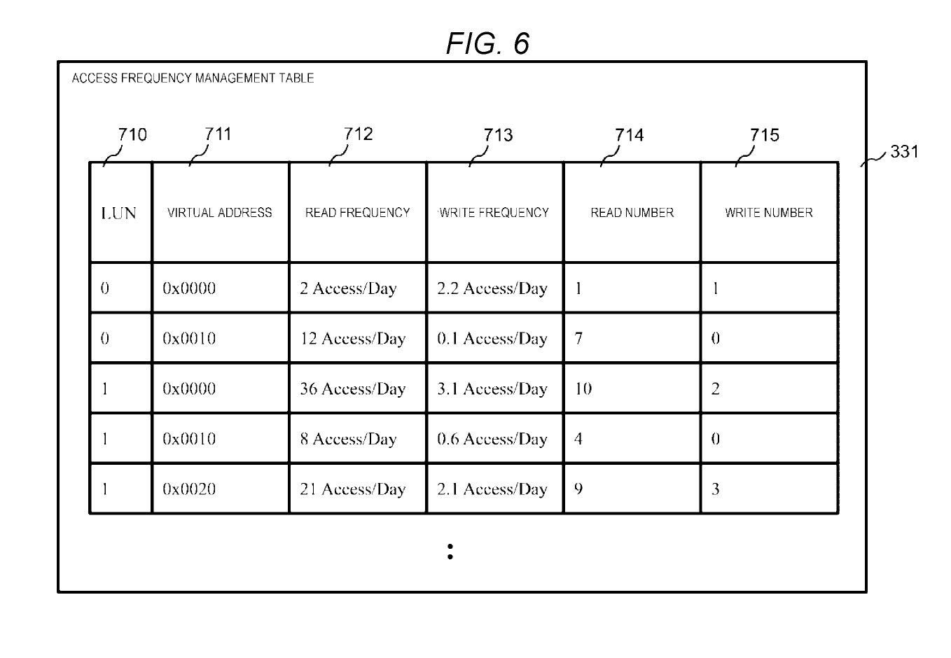

FIG. 6 is a diagram illustrating a configuration of the access frequency management table according to the first embodiment.

The access frequency management table 331 is a 2-dimensional table used to manage access frequency information regarding a frequency of access for each logical page of the LVOL and has a row for each logical page. The row (entry) of the access frequency management table 331 includes an LUN field 710, a virtual address field 711, a read frequency field 712, a write frequency field 713, a read number field 714, and a write number field 715.

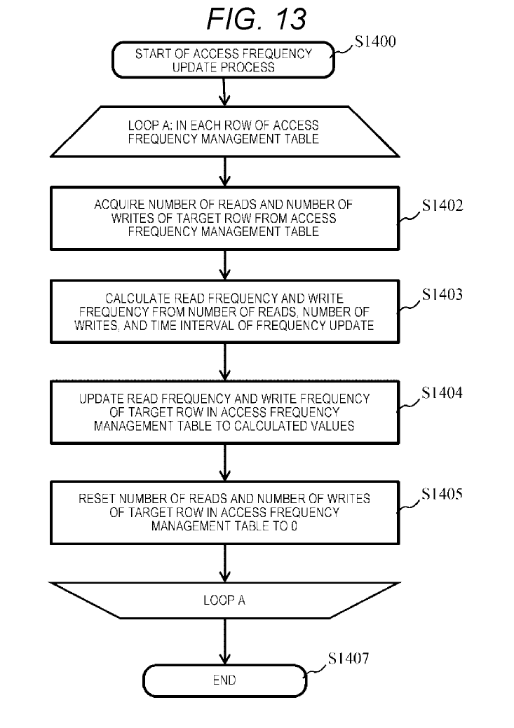

In the LUN field 710, the LUN of the LVOL to which the logical page corresponding to the row is stored. In the virtual address field 711, a start address (virtual address) of the logical page in the LVOL is stored. In the read frequency field 712, a read frequency from the logical page corresponding to the row (read frequency: read access frequency) is stored. According to the embodiment, in the read frequency field 712, a read frequency at a time interval from execution at the time before last to execution at the previous time in the access frequency update process (see FIG. 13) is stored. In the write frequency field 713, a write frequency on the logical page corresponding to the row (write frequency: write access frequency) is stored. According to the embodiment, in the write frequency field 713, a write frequency at a time interval from execution at the time before last to execution at the previous time in the access frequency update process is stored. In the read number field 714, a read number from the logical page corresponding to the row at a time interval to the current time from execution of a previous access frequency update process is stored. In the write number field 715, a write number on the logical page corresponding to the row at a time interval to the current time from the execution of the previous access frequency update process is stored.

The read frequency and the write frequency may be an access number per day (Access/Day) or may be an expression in other unit. In the example illustrated in FIG. 6, in the access frequency management table, rows of the logical pages are arranged in an ascending order of values of the LUN field 710 and the virtual address field 711, but the invention is not limited thereto. The rows of the logical pages may be arranged in any order. The information managed in the access frequency management table 331 may be managed in a data structure other than the table.

Next, the virtual address conversion table 332 will be described.

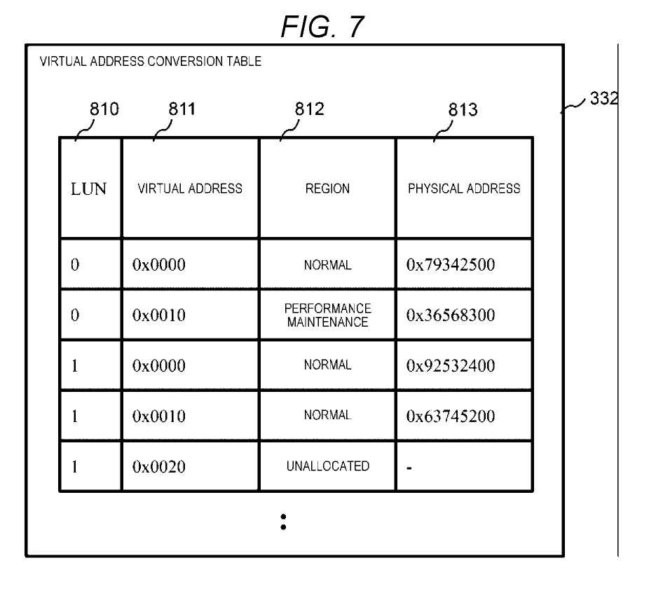

FIG. 7 is a diagram illustrating a configuration of the virtual address conversion table according to the first embodiment.

The virtual address conversion table 332 is a table indicating a correspondent relation between virtual addresses allocated to logical pages and physical addresses of physical pages allocated to the logical pages and has a row for each logical page. The rows of the virtual address conversion table 332 include an LUN field 810, a virtual address field 811, a region field 812, and a physical address field 813.

In the LUN field 810, the LUN of the LVOL to which the logical page corresponding to the row belongs is stored. In the virtual address field 811, a start address of the logical page in the LVOL is stored. In the region field 812, information (region information) indicating the region of the physical page allocated to the logical page corresponding to the row is stored. In the region field 812, one of “unallocated” indicating that the physical page is not allocated to the logical page corresponding to the row, “normal” indicating that the physical page of the normal region is allocated to the logical page corresponding to the row, and “performance maintenance” indicating that the physical page of the performance maintenance region is allocated to the logical page corresponding to the row is set. In the physical address field 813, a physical address of a head of the physical page allocated to the logical page corresponding to the row is stored. The physical address of the physical address field 813 is physical addresses of the physical pages of the RAID group corresponding to a region indicated by the region information of the region field 812 corresponding to the row.

In the example illustrated in FIG. 7, in the virtual address conversion table 332, the rows are arranged in ascending order of values of the LUN 810 and the virtual address 811, but the invention is not limited thereto. The rows may be arranged in any order. The information managed in the virtual address conversion table 332 may be managed in a data structure other than the table.

Next, the empty physical address management queue 333 will be described.

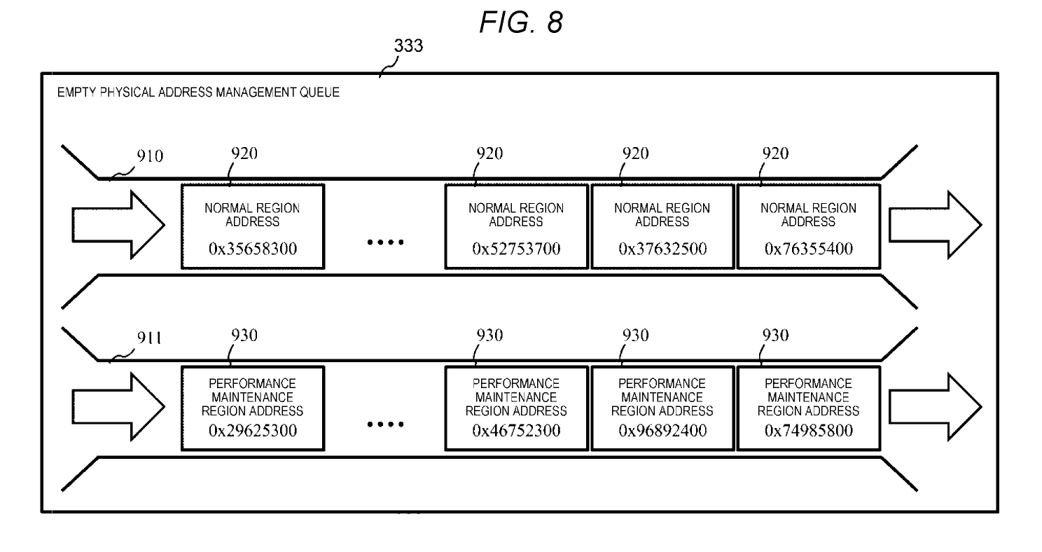

FIG. 8 is a diagram illustrating a configuration of the empty physical address management queue according to the first embodiment.

The empty physical address management queue 333 includes two queues, a normal region management queue 910 which is an example of second physical address management information and performance maintenance region management queue 911 which is an example of first physical address management information.

In the normal region management queue 910, head addresses 920 of the physical pages unallocated to the logical pages are maintained among the physical pages belonging to the normal region. In the normal region management queue 910, the number of head physical addresses of the normal region which are elements can be maintained by the number of physical pages belonging to the normal region to the maximum.

In the performance maintenance region management queue 911, head addresses 930 of the physical pages unallocated to the logical pages among the physical pages belonging to the performance maintenance region are maintained. In the performance maintenance region management queue 911, the number of physical addresses 930 of the performance maintenance region which are elements can be maintained by the number of physical pages belonging to the performance maintenance region to the maximum. In either the normal region management queue 910 or the performance maintenance region management queue 911, enqueueing and dequeueing of elements can be executed in a first-in-first-out (FIFO) scheme. The information managed in the empty physical address management queue 333 may be managed in a data structure such as a table other than the queue.

Next, a processing operation in the storage system 20 according to the first embodiment will be described.

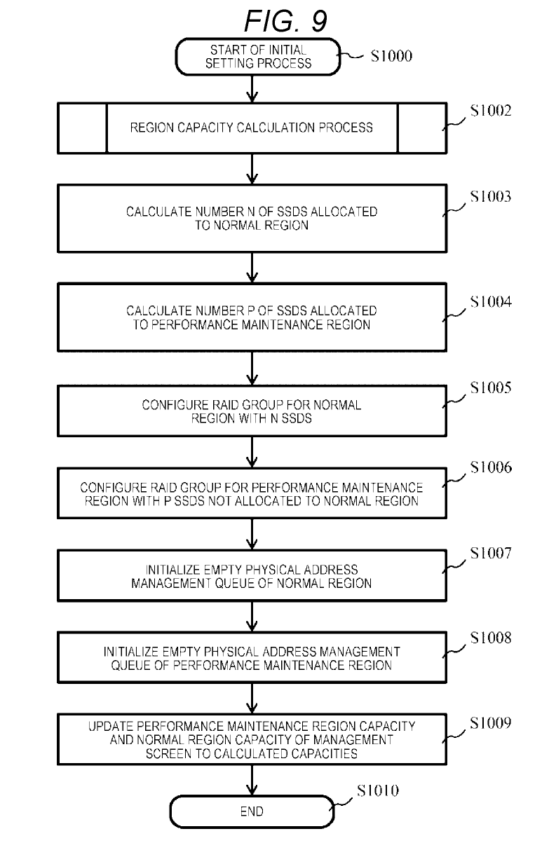

FIG. 9 is a flowchart illustrating an initial setting process according to the first embodiment.

The initial setting process (S1000) is executed, for example, by causing the processor 211 to execute an initial setting program 320 when the storage controller 200 is first activated.

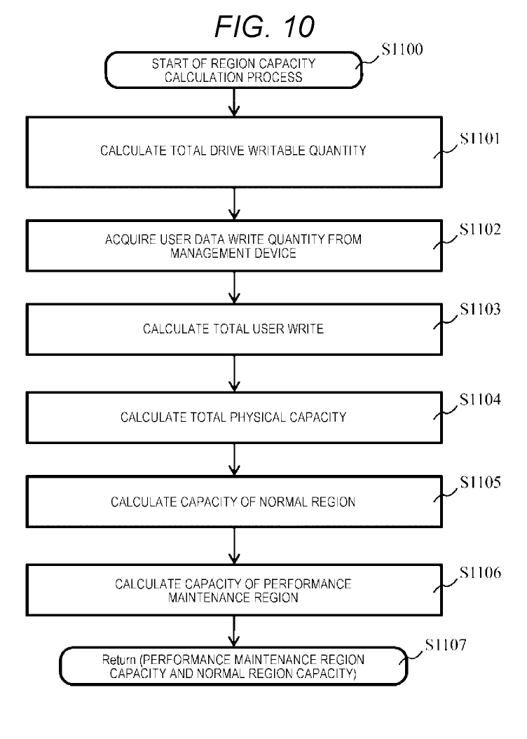

When the initial setting process (S1000) starts, the processor 211 executing the initial setting program 320 calls the region capacity calculation program 325 and causes the region capacity calculation program 325 to execute a region capacity calculation process (see FIG. 10) of calculating capacities to be allocated to the performance maintenance region and the normal region (S1002). A normal region capacity and a performance maintenance region capacity are returned as return values from the region capacity calculation process.

Subsequently, the processor 211 calculates the number N of SSDs 220 to be allocated to the normal region (S1003). The processor 211 calculates the number N by the following expression:

number N=Ceil (normal region capacity/capacity per SSD).

That is, the processor 211 calculates the number N by dividing the capacity to be allocated to the normal region (the normal region capacity) by a capacity stored in the capacity field 610 in the row of the connection device management table 330 and rounding up the quotient.

Subsequently, the processor 211 calculates the number P of SSDs 220 to be allocated to the performance maintenance region (S1004). The processor 211 calculates the number P by the following expression:

number P=connection number−N.

That is, the processor 211 calculates the number P by subtracting the number N from a connection number of the connection number field 612 in the row of the connection device management table 330.

Subsequently, the processor 211 constructs the RAID group 420 that forms the normal region (S1005). Specifically, the processor 211 arbitrarily selects the number N from the SSDs 220 connected to the storage controller 200, allocates the storage regions of the SSDs 220 to the normal region, and constructs the RAID group 420 with the SSDs 220. The processor 211 may construct one RAID group using all of the number N of SSDs 220 or may construct a plurality of RAIDs so that the storage regions of the RAID groups are virtualized to be treated as one address space. An RAID level of the constructed RAID group 420 may be any level. When the RAID level of the RAID group 420 is a level other than RAID 0, it is necessary to prepare a parity SSD separately.

Subsequently, the processor 211 constructs the RAID group 421 that forms the performance maintenance region (S1006). Specifically, the processor 211 allocates the storage regions of the SSDs 220 among the SSDs 220 not allocated to the normal region in S1005 to the performance maintenance region and constructs the RAID group 421 with the SSDs 220. The processor 211 may construct one RAID group using the SSDs 220 or may construct the plurality of RAID groups so that the storage regions of the RAID group are virtualized to be treated as one address space. An RAID level of the constructed RAID group 421 may be any level. When the RAID level of the RAID group 421 is a level other than RAID 0, it is necessary to prepare a parity SSD separately.

Subsequently, the processor 211 initializes the normal region management queue 910 (S1007). Specifically, the processor 211 enqueues a multiple of the size of the physical page (a head address of each physical page) in the normal region management queue 910 until a capacity less than the capacity of the RAID group 420 from 0. For example, when the size of the physical page is 1 MB (0x100000) and the size of the RAID group 420 is 4 GB (0x100000000), the processor 211 enqueues x00000, 0x100000, 0x200000, . . . , and 0xfff00000 in the normal region management queue 910.

Subsequently, the processor 211 initializes the performance maintenance region management queue 911 (S1008). Specifically, the processor 211 enqueues a multiple of the size of the physical page (a head address of each physical page) in the performance maintenance region management queue 911 until a capacity less than the capacity of the RAID group 421 from 0.

Subsequently, the processor 211 updates the management screen 500 of the management device 12 (S1009). Specifically, the processor 211 notifies the management device 12 of the capacity of the performance maintenance region and the capacity of the normal region calculated in S1002 via the network 13. On the other hand, the management device 12 receives the capacity of the performance maintenance region and the capacity of the normal region and displays the capacity of the performance maintenance region and the capacity of the normal region in the performance maintenance region capacity field 521 and the normal region capacity field 522 of the management screen 500. After S1009, the processor 211 ends the initial setting process (S1010).

Subsequently, a region capacity calculation process corresponding to S1002 of the initial setting process will be described.

FIG. 10 is a flowchart illustrating the region capacity calculation process according to the first embodiment.

The region capacity calculation process (S1100) is a process realized by causing the processor 211 to execute the region capacity calculation program 325 when the processor 211 calls the region capacity calculation program 325 (S1002 of the initial setting process), and is a process (subroutine) of calculating the capacities of the performance maintenance region and the normal region and returning a calculation result in the calling source.

When the region capacity calculation process (S1100) starts, the processor 211 calculates a total amount (total drive writable quantity) of writable data quantities on the SSDs 220 (S1101). Specifically, the processor 211 acquires the capacity of one SSD, the rewrite resistance, and the connection number with reference to the capacity field 610, the rewrite resistance field 611, and the connection number field 612 of the connection device management table 330 and calculates a product of the capacity, the rewrite resistance, and the connection number as the total drive writable quantity. Here, as understood from the calculation expression, the total drive writable quantity is not a simultaneously writable data quantity but a data amount by which data can be written while repeating execution such as writing of data, subsequently erasing of the data, writing data, and subsequently erasing the data.

Subsequently, the processor 211 acquires a user data write quantity from the management device 12 (S1102). Specifically, the processor 211 inquires to the management device 12 about the user data write amount. In response to the inquiry, the management device 12 specifies a user data write quantity designated by the system manager in the user data write quantity field 511 of the management screen 500 and responds to the storage controller 200 with the specified user data write quantity. On the other hand, the processor 211 receives the response from the management device 12 to acquire the user data write quantity. A method of acquiring the user data write quantity is not limited to the foregoing PULL type information acquisition method. For example, a PUSH type information acquisition method in which the management device 12 spontaneously transmits the user data write amount to the storage controller 200 may be used.

Subsequently, the processor 211 calculates a total write quantity of the data by the user (a total user write quantity) (S1103). Specifically, the processor 211 calculates a product of the user data write amount acquired in S1102 and a product guarantee period (which is an example of an assumption period) of the storage system 20 and sets the product as the total user write amount. For example, when the user data write amount is 100 TB/Day and the product guarantee period is 5 years, the processor 211 calculates the total user write amount to 182.5 PB.

Subsequently, the processor 211 calculates a sum of the capacities of the SSDs 220 connected to the storage controller 200 (a total physical capacity) (S1104). Specifically, the processor 211 acquires a capacity per SSD and a connection number from the capacity field 610 and the connection number field 612 of the connection device management table 330 and obtains the total physical capacity by calculating a product of the capacity and the connection number.

Subsequently, the processor 211 calculates a capacity of the normal region (a normal region capacity) (S1105). Specifically, the processor 211 obtains a quotient obtained by dividing the total user write quantity calculated in S1103 by the total drive writable quantity calculated in S1101. Subsequently, the processor 211 obtains a product of the quotient and the total physical capacity calculated in S1104 and sets the product as the normal region capacity. When the normal region capacity is calculated through this calculation, a total writable data quantity is equal to or greater than the total user writable quantity in the normal region corresponding to the normal region capacity. That is, even when all the data to be written by the user is concentratedly written on the storage region of the normal region, it is possible to ensure that the SSDs 220 are used over a product guarantee period.

Subsequently, the processor 211 calculates the capacity of the performance maintenance region (a performance maintenance region capacity) (S1106). Specifically, the processor 211 subtracts the normal region capacity from the total physical capacity and sets the subtracted capacity value as the performance maintenance capacity. That is, the processor 211 sets a region other than the normal region in the total physical capacity of the SSDs 220 as the performance maintenance region. Subsequently, the processor 211 ends the region capacity calculation process and returns a processing result (that is, the normal region capacity and the performance maintenance region capacity) to the calling source (S1107).

Next, a read process will be described.

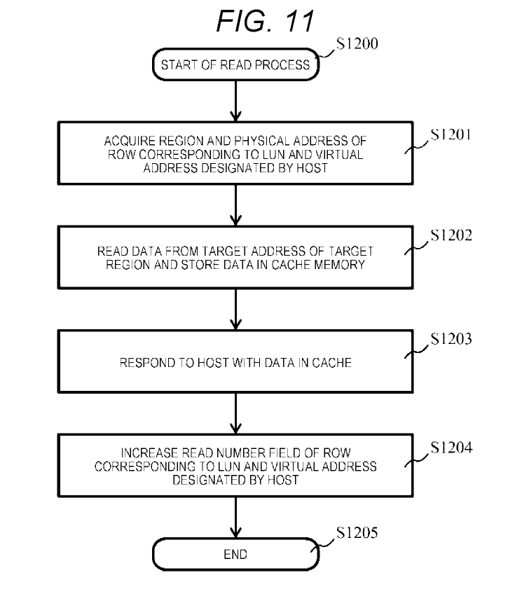

FIG. 11 is a flowchart illustrating a read process according to the first embodiment.

The read process (S1200) is executed by the processor 211 executing the data read program 321 when there is a read request to the storage controller 200 from the host 11. The read request includes the LUN indicating the LVOL of the read target and a virtual address indicating a logical page of the read target.

When the read request is received from the host 11, the processor 211 acquires a region including a physical page corresponding to the logical page indicated by the LUN and the virtual address included in the read request and a physical address of the region (S1201). Specifically, the processor 211 retrieves rows in which the LUN of the LUN field 810 and the virtual address of the virtual address field 811 match the LUN and the virtual address included in the read request by referring the rows of the virtual address conversion table 332 in order from the head row. Subsequently, the processor 211 acquires region information of the region field 812 and the physical address of the physical address field 813 of the rows found through the retrieval. A method of retrieving the corresponding rows from the virtual address conversion table 332 is not limited to the method of retrieving the rows in order from the head row. For example, a retrieving method in which another algorithm such as dichotomizing retrieval is used may be used.

Subsequently, the processor 211 reads read target data from a region corresponding to the acquired physical address in the RAID group corresponding to the region indicated by the region information acquired in S1201 and stores the read data in the cache storage device 212 (S1202). The processor 211 may cause the drive interface 214 to read data from the SSD 220 and store the read data in the cache storage device 212 by a direct memory access (DMA) function of the drive interface 214.

Subsequently, the processor 211 transmits the data stored in the cache storage device 212 in S1202 to the host 11 (S1203). The processor 211 may cause the network interface 210 to read the data from the cache storage device 212 and transmit the read data to the host 11 by the DMA function of the network interface 210.

Subsequently, the processor 211 updates the access frequency management table 331 in association with the read request (S1204). Specifically, the processor 211 retrieves rows in which the LUN of the LUN field 710 and the virtual address of the virtual address field 711 match the LUN and the virtual address included in the read request by referring the rows of the access frequency management table 331 in order from the head row. Subsequently, the processor 211 increases the value of the read number field 714 in the row found through the retrieval (+1). A method of retrieving the rows from the access frequency management table 331 is not limited to the foregoing method of retrieving the rows in order from the head row. For example, a retrieving method in which another algorithm such as dichotomizing retrieval is used may be used. After S1204, the processor 211 ends the read process (S1205).

Next, a write process will be described.

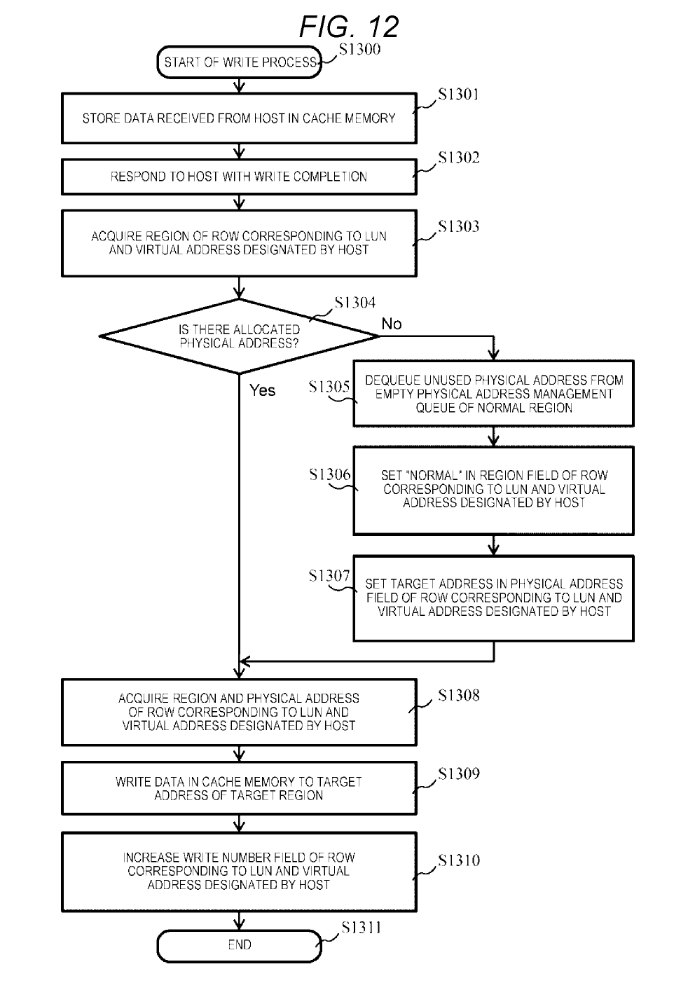

FIG. 12 is a flowchart illustrating the write process according to the first embodiment.

The write process (S1300) is executed by the processor 211 executing the data write program 322 when there is a write request to the storage controller 200 from the host 11. The write request includes the LUN indicating the LVOL of a write target, a virtual address indicating a logical page of the write target, and data of the write target (write target data).

When the write request is received from the host 11, the processor 211 stores the write target data included in the write request in the cache storage device 212 (S1301). Subsequently, the processor 211 responds to the host 11 with write completion (S1302). In the embodiment, since the write-back-cache is assumed, the response of the write completion is performed immediately after S1301. However, the invention is not limited thereto. A write completion response may be performed at any timing after S1301, or write-through cache may be assumed and the write completion response may be performed after destage of the write target data to the SSD 220.

Subsequently, the processor 211 acquires information regarding a region including a physical page corresponding to the virtual address and the LUN included in the write request and a physical address of the region (S1303). Specifically, the processor 211 retrieves rows in which the LUN of the LUN field 810 and the virtual address of the virtual address field 811 match the LUN and the virtual address included in the write request by referring the rows of the virtual address conversion table 332 in order from the head row. Subsequently, the processor 211 acquires region information of the region field 812 and the physical address of the physical address field 813 of the rows found through the retrieval. A method of retrieving the corresponding rows from the virtual address conversion table 332 is not limited to the method of retrieving the rows in order from the head row. For example, a retrieving method in which another algorithm such as dichotomizing retrieval is used may be used.

Subsequently, the processor 211 determines whether there is the physical page corresponding to the virtual address and the LUN included in the write request (S1304). As a result, when there is no physical page corresponding to the virtual address, that is, the information of the region acquired in S1303 is “unallocated” (No in S1304), it is meant that there is no physical page corresponding to the virtual address. Therefore, the processor 211 causes the process to proceed to S1305. Conversely, when there is the physical page corresponding to the virtual address (Yes in S1304), that is, the information of the region acquired in S1303 is other information, it is meant that there is the physical page corresponding to the virtual address. Therefore, the processor 211 causes the process to proceed to S1308.

In S1305, the processor 211 dequeues the unused physical address 920 in the normal region from the normal region management queue 910. Subsequently, the processor 211 updates the region field 812 of the virtual address conversion table 332 (S1306). Specifically, the processor 211 sets “normal” in the region field 812 in the rows found in S1303.

Subsequently, the processor 211 updates the value of the physical address field 813 of the virtual address conversion table 332 (S1307). Specifically, the processor 211 sets the physical address dequeued in S1304 in the physical address field 813 in the rows found in S1303.

When there is the physical page corresponding to the virtual address (Yes in S1304) or when S1307 is executed, the processor 211 acquires the information regarding the region of the region field 812 in the row found in S1303 and the physical address of the physical address field 813 (S1308).

Subsequently, the processor 211 destages the write target data stored in the cache storage device 212 to the SSD 220 (S1309). Specifically, the processor 211 writes the write target data stored in the cache storage device 212 in the physical address acquired in S1308 in the RAID group of the region indicated by the information regarding the region acquired in S1308. The processor 211 may cause the drive interface 214 to write the write target data on the SSD 220 from the cache storage device 212 by a direct memory access (DMA) function of the drive interface 214.

Subsequently, the processor 211 updates the access frequency management table 331 (S1310). Specifically, the processor 211 retrieves rows in which the LUN of the LUN field 710 and the virtual address of the virtual address field 711 match the LUN and the virtual address included in the write request by referring the rows of the access frequency management table 331 in order from the head row. Subsequently, the processor 211 increases the value of the write number field 715 in the row found through the retrieval (+1). A method of retrieving the rows from the access frequency management table 331 is not limited to the method of retrieving the rows in order from the head row. For example, a retrieving method in which another algorithm such as dichotomizing retrieval may be used. After S1310, the processor 211 ends the write process (S1311).

Next, an access frequency update process will be described.

FIG. 13 is a flowchart illustrating the access frequency update process according to the first embodiment.

The access frequency update process is realized, for example, by causing the processor 211 to execute the access frequency update program 323 periodically for each predetermined period (for example 24 hours). Setting of the period at which the access frequency update process is executed may be received, for example, from the system manager via the management screen 500 of the management device 12.

The processor 211 repeatedly executes processes (S1402 to S1405) of the loop A by setting each row of the access frequency management table 331 as a processing target. In the description of the access frequency update process, a row of the processing target is referred to as a target row.

In the processes of the loop A, the processor 211 acquires a read number and a write number from the read number field 714 and the write number field 715 of the target row (S1402). Subsequently, the processor 211 calculates a read frequency and a write frequency (S1403). Specifically, the processor 211 calculates the read frequency by dividing the read number acquired in S1402 by an execution period of the access frequency update process. The processor 211 calculates the write frequency by dividing the write number acquired in S1403 by the execution period of the access frequency update process.

Subsequently, the processor 211 updates the values of the read frequency field 712 and the write frequency field 713 of the target row to the read frequency and the write frequency calculated in S1405 (S1404). Subsequently, the processor 211 resets the values of the read number field 714 and the write number field 715 of the target row to 0 (S1405). When there is a row which is not the processing target, the process is executed setting the row as a subsequent target row.

Thereafter, after the processes of the loop A are executed by setting all the rows of the access frequency management table 331, the processor 211 ends the loop A and ends the access frequency update process (S1407).

Next, a migration process will be described.

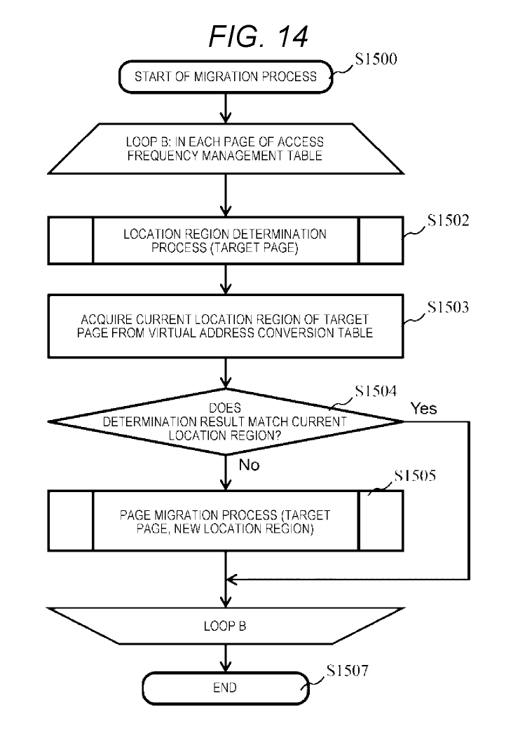

FIG. 14 is a flowchart illustrating a migration process according to the first embodiment.

The migration process is realized, for example, by causing the processor 211 to execute the migration program. 324 periodically for each predetermined period (for example, 24 hours). Setting of the period at which the migration process is executed may be received, for example, from the system manager via the management screen 500 of the management device 12. The execution period of the migration process may be the same as or may be different from the execution period of the access frequency update process.

The processor 211 repeatedly executes processes (S1502 to S1505) of a loop B by setting each row of the access frequency management table 331 as a processing target. In the description of the migration process, a row of the processing target is referred to as a target row and a logical page corresponding to the target row is referred to as a target logical page.

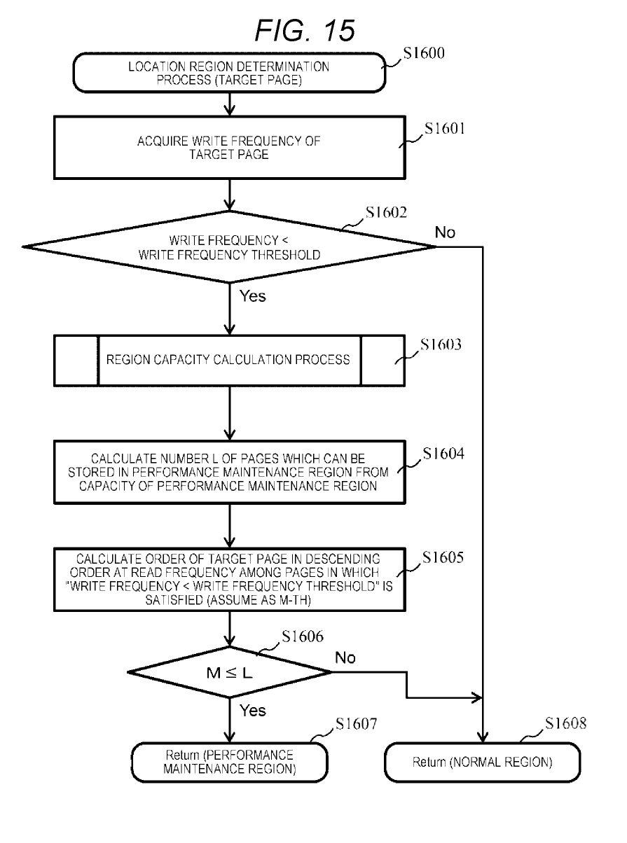

In the processes of the loop B, the processor 211 calls the location region determination program 326 and causes the location region determination program 326 to execute a location region determination process (see FIG. 15) of determining a region (new region) in which the physical page corresponding to the target logical page is located (S1502). When the processor 211 calls the location region determination program 326, for example, information by which the target row can be uniquely specified (for example, the LUN and the virtual address corresponding to the logical page) is set as an argument. A return value from the location region determination process is information indicating the new region in which the target logical page is located.

Subsequently, the processor 211 acquires information regarding the region (the current region) in which the physical region corresponding to the target logical page is located, from the region field 812 of the virtual address conversion table 332 (S1503). For example, when the access frequency management table 331 and the virtual address conversion table 332 maintain the rows corresponding to the logical pages in the same order, the processor 211 acquires the information regarding the region from the region field 812 of the rows of the virtual address conversion table 332 in the same order as the target rows. When the access frequency management table 331 and the virtual address conversion table 332 do not maintain the rows corresponding to the logical pages in the same order, the processor 211 retrieves the rows of the virtual address conversion table 332 in which the values of the LUN field 710 and the virtual address field 711 of the target row match the values of the LUN field 810 and the virtual address field 811 and acquires the information regarding the region from the region field 812 in the row obtained through the retrieval.

Subsequently, the processor 211 determines whether the new region obtained in S1502 and corresponding to the target logical page matches the current region obtained in S1503 (S1504). As a result, when the new region matches the current region (Yes in S1504), the processor 211 moves the process to the end of the loop. Conversely, when the new region does not match the current region (No in S1504), the processor 211 causes the process to proceed to S1505.

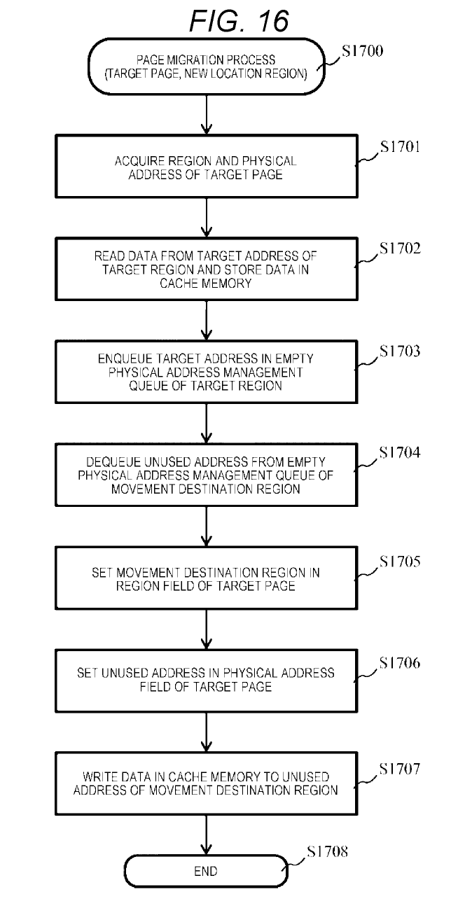

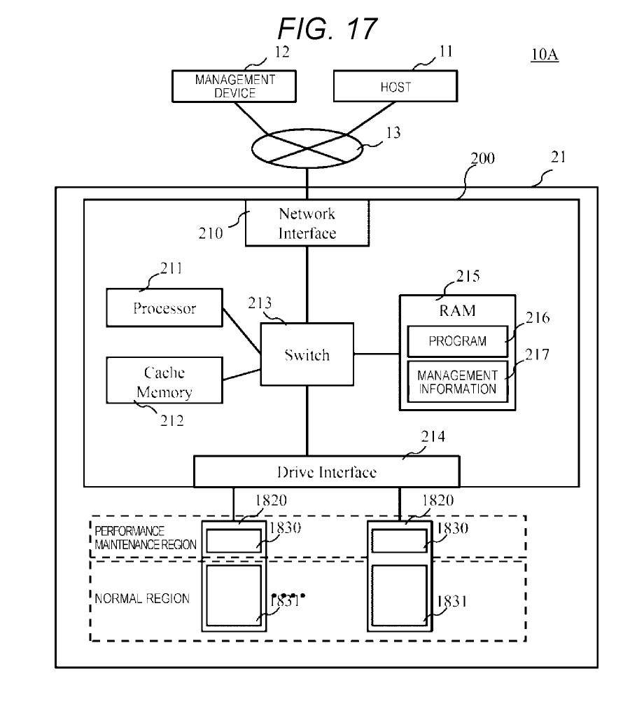

In S1505, the processor 211 calls the page migration program 327 and causes the page migration program 327 to execute a page migration process (see FIG. 16) of moving data corresponding to the target logical page from the current region to the new region (S1505). When the processor 211 calls the page migration program 327, for example, information by which the target logical page can be uniquely specified (for example, the LUN and the virtual address) and information indicating the new region are set as arguments. Subsequently, when there is a row which is not the processing target, the processor 211 executes the processes of the loop B setting the row as the target row.

Thereafter, after the processes of the loop B are executed setting all the rows of the access frequency management table 331 as the processing targets, the processor 211 ends the loop B and ends the migration process (S1507).

Next, the location region determination process corresponding to S1502 of the migration process will be described.

FIG. 15 is a flowchart illustrating the location region determination process according to the first embodiment.

The location region determination process (S1600) is a process realized by causing the processor 211 to execute the location region determination program 326 when the processor 211 calls the location region determination program 326 and is a process (subroutine) of determining a region in which the physical page corresponding to the logical page is located and returning a determination result to the calling source.

When the location region determination process (S1600) starts, the processor 211 acquires a write frequency of the target logical page designated as an argument from the access frequency management table 331 (S1601). For example, when the target logical page in the argument is designated with a row number of the access frequency management table 331, the processor 211 specifies a row based on the row number and acquires a write frequency from the write frequency field 713 in the specified row. On the other hand, when the target logical page is designated as an argument with the LUN and the virtual address, the processor 211 retrieves the access frequency management table 331 with the designated LUN and virtual address and acquires the write frequency from the write frequency field 713 in the row obtained through the retrieval.

Subsequently, the processor 211 determines whether the write frequency acquired in S1601 is less than a predetermined threshold (a predetermined value: a write frequency threshold) which the storage controller 200 has statically (S1602). As a result, when the acquired write frequency is less than the write frequency threshold (Yes in S1602), the processor 211 causes the process to proceeds to S1603. Conversely, when the acquired write frequency is not less than the write frequency threshold (No in S1602), the processor 211 causes the process to proceed to S1608 and returns information indicating that the new region of the target logical page is the normal region to the calling source.

In S1603, the processor 211 calls the region capacity calculation program 325 and causes the region capacity calculation program 325 to execute a region capacity calculation process (see FIG. 10) of calculating capacities to be allocated to the performance maintenance region and the normal region. The normal region capacity and the performance maintenance region capacity are returned from the region capacity calculation process.

The processor 211 calculates the number L of pages which can be stored in the performance maintenance region from the obtained performance maintenance region capacity (S1604). Specifically, the processor 211 calculates the number L of pages by dividing the performance maintenance region capacity obtained in S1603 by the size of the physical page.

Subsequently, the processor 211 calculates an order of the target logical page in a descending order at the read frequency among the logical pages of which the write frequency is less than the write frequency threshold. Here, the calculated order is assumed to be an M-th order. M can be calculated, for example, by counting the number of logical pages of which the write frequency is less than the write frequency threshold and the read frequency is equal to or greater than the read frequency of the target logical page while scanning the access frequency management table 331 from the head.

Subsequently, the processor 211 determines whether M is equal to or less than the number L of pages (S1606). As a result, when M is equal to or less than L (Yes in S1606), data is meant to be appropriate to be stored in the performance maintenance region. Therefore, the processor 211 causes the process to proceed to S1607 and returns information indicating that the new region of the target logical page is the performance maintenance region to the calling source. Conversely, when M is not equal to or less than L (No in S1606), the processor 211 causes the process to proceed to S1608 and returns information indicating that the new region of the target logical page is the normal region to the calling source.

Next, a page migration process corresponding to S1505 of the migration process will be described.

FIG. 16 is a flowchart illustrating a page migration process according to the first embodiment.

The page migration process (S1700) is a process realized by causing the processor 211 to execute the page migration program 327 when the processor 211 calls the page migration program 327 and is a process (subroutine) of moving data of a target logical page to the physical page of a designated region.

The processor 211 specifies a row corresponding to the target logical page from the virtual address conversion table 332 based on information by which the target logical page received as the argument can be specified, acquires information regarding a region from the region field 812 in the specified row, and acquires a physical address from the physical address field 813 (S1701). For example, when the target logical page in the argument is designated with a row number of the virtual address conversion table 332, the processor 211 specifies a row based on the row number and acquires the physical address (referred to as a target physical address in the description of the process) and the information regarding the region from the region field 812 and the physical address field 813 of the specified row. On the other hand, when the target logical page is designated as an argument with the LUN and the virtual address, the processor 211 retrieves the virtual address conversion table 332 with the designated LUN and virtual address and acquires the physical address (referred to as a target physical address in the description of the process) and the region information from the region field 812 and the physical address field 813 of the row obtained through the retrieval.

Subsequently, the processor 211 reads data from the storage region corresponding to the target physical address of the RAID group corresponding to a region (referred to as a target region in the description of the process) indicated by the acquired region information and stores the read data in the cache storage device 212 (S1702). Subsequently, the processor 211 opens the target physical address (step S1703). That is, the processor 211 enqueues the target physical address in a queue corresponding to the target region of the empty physical address management queue 333. The target physical address may be enqueued after the data of the physical page corresponding to the physical target address is erased.

Subsequently, the processor 211 allocates a new physical page to the target logical page (S1704). Specifically, the processor 211 dequeues the physical address (920 or 930) of the movement destination region (the new region) designated with the argument from the empty physical address management queue 333. Subsequently, the processor 211 sets the movement destination region designated with the argument in the region field 812 in the row of the target logical page of the virtual address conversion table 332 (S1705). Subsequently, the processor 211 sets the physical address acquired in S1704 in the physical address field 813 of the virtual address conversion table 332 (S1706). Subsequently, the processor 211 destages the data stored in the cache storage device 212 to the storage region of the SSD 220 corresponding to the target physical address of the new region (S1707) and ends the migration process (S1708).

As described above, in the computer system according to the embodiment, only the data of which the write frequency is less than the write frequency threshold is located in the performance maintenance region. Therefore, the data maintenance characteristics of the performance maintenance region are maintained higher compared to the normal region. As a result, the data located in the performance maintenance region can be read at a lower delay time compared to a case in which the data is located in the normal region. By preferentially storing the data of which the read frequency is high in the performance maintenance region, it is possible to minimize the average read latency in the storage system 20 in the best effort. Data stored in the normal region despite a read frequency which is high to the same extent as the data stored in the performance maintenance region can be read at the low delay time compared to a case in which the data located in the performance maintenance region is located in the normal region. This is because the number of failure bits is equal to or less than the number of bits correctable by an ECC since the data located in the normal region is data of which the write frequency is equal to or greater than the write frequency threshold and can be frequently rewritten. In this way, in the computer system according to the embodiment, it is possible to improve the read latency overall in the storage system 20, that is, the average read latency.

Next, a computer system according to a second embodiment will be described.

In the computer system according to the first embodiment, the SSDs with the capacities resistant to data write by a user are allocated to the normal region and the other SSDs are allocated to the performance maintenance region. That is, the capacity of each region is set in units of the SSDs. Therefore, there is a possibility that the capacity of the normal region is greater than a capacity necessary for data write by the user (the total user data write quantity) by a capacitor close to the drive capacity of the SSD to the maximum. In a computer system 10A according to the second embodiment, however, both the regions are partitioned inside an SSD so that the capacities of both the regions can be set at finer granularity. By setting the capacities of both the regions at the finer granularity, for example, it is possible to allocate a more capacity to the performance maintenance region and further improve the average read latency.

First, the computer system according to the second embodiment will be described.

FIG. 17 is a diagram illustrating an overall configuration of the computer system according to the second embodiment. The same reference numerals are given to the same configurations as those of the first embodiment and the description thereof will not be repeated.

One or more SSDs 1820 are connected to the storage controller 200 of the storage system 21. The SSDs 1820 are SSDs that have the same characteristics. In the embodiment, the SSDs 1820 are SSDs that all have the same memory cell configuration and the same capacity and the same rewrite resistance. The SSD 1820 has a function of partitioning a physical storage region inside the SSD and an interface with which partitioning of the physical storage region can be instructed from the storage controller 200. The storage controller 200 partitions the physical region of each SSD 1820 into a physical region 1830 for a performance maintenance region and a physical region 1831 for a normal region, for example, at the same ratio as the other SSDs 1820 for management.

As in the first embodiment, the RAM 215 of the storage controller 200 stores the data read program 321, the data write program 322, the access frequency update program 323, the migration program 324, the region capacity calculation program 325, the location region determination program 326, the page migration program. 327, the connection device management table 330, the access frequency management table 331, the virtual address conversion table 332, and the empty physical address management queue 333.

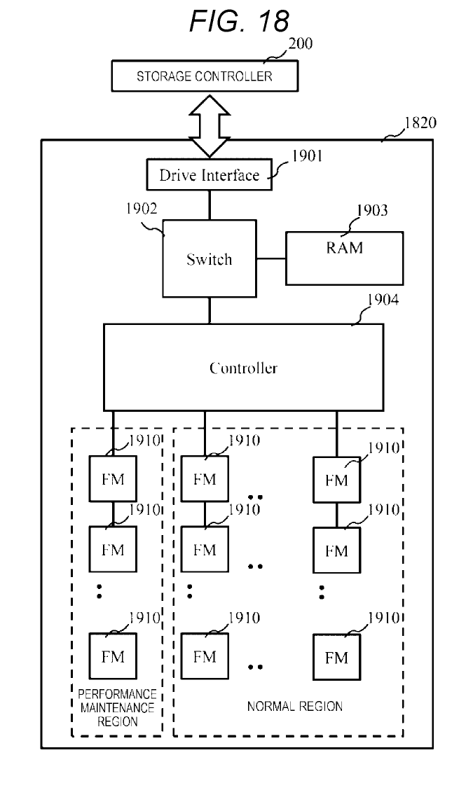

Next, a configuration of the SSD 1820 will be described. FIG. 18 is a diagram illustrating a configuration of the SSD according to the second embodiment.

The SSD 1820 includes a drive interface 1901, a controller 1904, a RAM 1903, a switch 1902 connecting them, and a plurality of flash memory chips (FM) 1910.

The drive interface 1901 is connected to the storage controller 200 which is a high-order device so that communication is possible. The controller 1904 performs analyzing of a read request or a write request received from the storage controller 200 and controlling of the flash memory chips 1910 based on a request. The controller 1904 exclusively allocates the flash memory chips 1910 to a plurality of regions in response to a request to partition of the physical region from the storage controller 200. In the embodiment, the controller 1904 partitions the plurality of flash memory chips 1910 into the flash memory chips 1910 of the performance maintenance region and the flash memory chips 1910 of the normal region. Since the physically different flash memory chips 1910 can be allocated to the respective regions, the performance maintenance characteristics of both the regions deteriorate independently in accordance with a data write quantity on each region. FIG. 18 illustrates an example in which the region is partitioned in a unit of the flash memory chip 1910, but the invention is not limited thereto. The granularity at the time of partitioning the region may be, for example, a die unit or a plane unit inside the flash memory chip 1910 or a block unit which is an erasure unit in the flash memory chip 1910.

Next, a processing operation in the storage system 21 according to the second embodiment will be described.

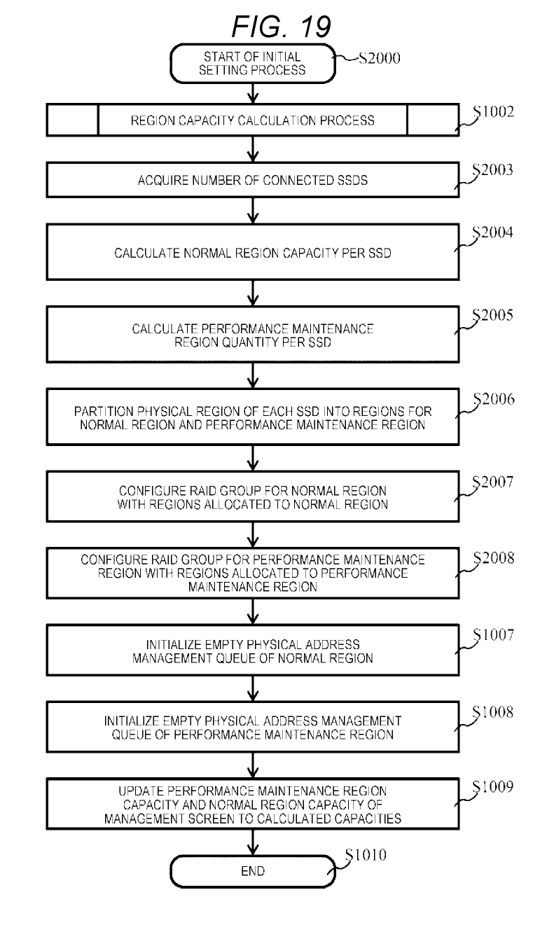

FIG. 19 is a flowchart illustrating an initial setting process according to the second embodiment. The same reference numerals are given to the same portions as the initial setting process according to the first embodiment illustrated in FIG. 9 and the description thereof will not be repeated.

In S2003, the processor 211 acquires a connection number to the SSDs 1820 connected to the storage controller 200 from the connection number field 612 of the connection device management table 330. Subsequently, the processor 211 calculates the normal region capacity allocated to each SSD 1820 (S2004). Specifically, the processor 211 calculates the normal region capacity to be allocated to each SSD 1820 by dividing the normal region capacity of the whole storage system 21 calculated in S1002 by the connection number of the SSDs acquired in S2003.

Subsequently, the processor 211 calculates the performance maintenance region capacity to be allocated to each SSD 1820 (S2005). Specifically, the processor 211 calculates the performance maintenance region capacity to be allocated to each SSD 1820 by dividing the performance maintenance region capacity of the whole storage system 21 calculated in S1002 by the connection number of the SSDs obtained in S2003.

Subsequently, the processor 211 partitions the physical storage region of each SSD 1820 into the regions for the normal region and the performance maintenance region with regard to the SSDs 1820 connected to the storage controller 200 (S2006). Specifically, the processor 211 partitions the physical storage region of each SSD 1820 using an I/F provided by the SSD 1820 via the drive interface 214.

Subsequently, the processor 211 generates an RAID group for the normal region using the region allocated for the normal region in the physical region of each SSD 1820 (S2007). Subsequently, the processor 211 generates the RAID group for the performance maintenance region using the region allocated for the performance maintenance region in the physical region of each SSD 1820 (S2008).

As described above, in the computer system according to the second embodiment, the partitioned performance maintenance region and normal region can be managed inside the SSD. For example, the capacity can be allocated at the finer granularity to the normal region. Thus, the storage region in the SSD can also be effectively used. Since the capacity can be allocated to the normal capacity at fine granularity, the more capacity can be allocated to the performance maintenance region. Thus, more data can be stored in the performance maintenance region and the average read latency in the computer system can be further improved. Since the performance maintenance region and the normal region are provided in each SSD, the read and write processes in the performance maintenance region and the read and write processes in the normal region can be distributed to the SSDs to be performed. Therefore, it is possible to improve process efficiency of the read and write processes in the storage system 21.

The invention is not limited to the above-described embodiment and can be appropriately modified within the scope of the invention without departing from the gist of the invention.

For example, in the foregoing embodiment, the storage region of one or more SSDs with the same characteristics is partitioned into two regions, the performance maintenance region and the normal region, but the invention is not limited thereto. For example, the performance maintenance region, the normal region, and other regions may be provided, the performance maintenance region may be further partitioned into a plurality of regions, or the normal region may be further partitioned into a plurality of regions.

In the foregoing embodiment, the example in which the plurality of SSDs that has the same capacity and the same rewrite resistance are used has been described, but the invention is not limited thereto. A plurality of SSDs that have the same memory cell configuration and different capacities may be used. For example, SSDs that have the same memory cell configuration and the same rewrite resistance or substantially the same rewrite resistance per unit capacity may be used.

In the foregoing embodiment, the data of a logical page located in a predetermined order from the logical page with a higher read frequency in the data of the logical pages of which the write frequency is less than the write frequency threshold is stored in the performance maintenance region, but the invention is not limited thereto. For example, when data satisfies that the write frequency is less than the write frequency threshold and the read frequency is equal to or greater than the predetermined threshold, the data may be stored in the performance maintenance region.

In the foregoing embodiment, the capacity of the normal region is determined and the capacity obtained by excluding the capacity of the normal region from the whole capacity is set in the performance maintenance region, but the invention is not limited thereto. The capacity of the performance maintenance region may be at least a part of the capacity obtained by excluding the capacity of the normal region from the whole capacity. The capacity of the performance maintenance region may be determined in advance and at least a part of the capacity obtained by excluding the capacity of the performance maintenance region from the whole capacity may be set as the capacity of the normal region.

In the foregoing embodiment, the used capacities of the performance maintenance region and the normal region are displayed on the management screen 500, but the invention is not limited thereto. Empty capacities of the performance maintenance region and the normal region may be displayed.

In the foregoing embodiment, so-called high-frequency refresh may be executed as necessary.

In the foregoing embodiment, some or all of the processes executed by the processor may be executed with a dedicated hardware circuit. A program according to the foregoing embodiment may be installed from a program source. A program source may be a program distribution server or a storage medium (for example, a portable storage medium).

What is claimed is:

1. A storage system capable of making connection to one or more nonvolatile semiconductor memory devices and capable of controlling inputting and outputting of data to and from a storage region of the nonvolatile semiconductor memory device, the storage system comprising:
a processor that executes a process,
wherein the processor manages a part of a storage region provided by the one or more nonvolatile semiconductor memory devices with the same characteristics as a first storage region used to store predetermined data,
determines data to be stored in the first storage region in data of which a write access frequency is less than a predetermined value, stores the data in the first storage region, and
stores data determined not to be stored in the first storage region in a second storage region which is different from the first storage region and is provided by the one or more nonvolatile semiconductor memory devices with the same characteristics.

2. The storage system according to claim 1,
wherein the processor determines data of which a read access frequency is higher in preference to the data of which the write access frequency is less than the predetermined value, as the data to be stored in the first storage region.

3. The storage system according to claim 2,
wherein the processor determines data which is within a predetermined order from the data of which read access frequency is high and is the data of which the write access frequency is less than the predetermined value, as the data to be stored in the first storage region.

4. The storage system according to claim 1,
wherein the plurality of nonvolatile semiconductor memory devices are connected, and
wherein the processor manages storage regions of some of the nonvolatile semiconductor memory devices among the plurality of nonvolatile semiconductor memory devices as the first storage region.

5. The storage system according to claim 1,
wherein the processor manages storage regions of some of the nonvolatile semiconductor memory devices as storage regions forming the first storage region.

6. The storage system according to claim 1,
wherein the processor receives a data write quantity for each predetermined period in which a user stores the data in the nonvolatile semiconductor memory device,
calculates a storage capacity necessary as the second storage region in the nonvolatile semiconductor memory device based on the data write quantity, and
manages a storage region of the calculated storage capacity in the nonvolatile semiconductor memory device as the second storage region and manages at least a part of a storage region of a capacity obtained by excluding the calculated storage capacity from a total capacity of the nonvolatile semiconductor memory device as the first storage region.

7. The storage system according to claim 6,
wherein the storage capacity necessary as the second storage region is a storage capacity in which a lifetime of the nonvolatile semiconductor memory device does not end even when the data write quantity of data is written over a predetermined assumption period.

8. The storage system according to claim 1,
wherein the processor displays values of the storage capacity of the second storage region and the storage capacity of the first storage region on a predetermined display device.

9. The storage system according to claim 1,
wherein first physical address management information used to manage an address of a writable physical page of the first storage region and a second physical address management information used to manage an address of a writable physical page of the second storage region are stored in a memory unit, and
wherein the processor allocates physical pages to logical pages based on the first physical address management information and the second physical address management information.

10. The storage system according to claim 1,
wherein the processor manages access frequency information regarding a read access frequency and a write access frequency with regard to data of the logical pages for each logical page in which data is stored,
determines a region in which the data stored in the logical page between the first storage region and the second storage region is stored based on the access frequency information, and
moves the data stored in the logical page to the determined region when the data stored in the logical page is stored in a region different from the determined region.

11. The storage system according to claim 1,
wherein the processor displays used capacities and empty capacities of the first storage region and the second storage.

12. A data management method by a storage system capable of making connection to one or more nonvolatile semiconductor memory devices and capable of controlling inputting and outputting of data to and from a storage region of the nonvolatile semiconductor memory device, the data management method comprising:
managing a part of a storage region provided by the one or more nonvolatile semiconductor memory devices with the same characteristics as a first storage region used to store predetermined data;
determining data to be stored in the first storage region in data of which a write access frequency is less than a predetermined value and storing the data in the first storage region; and
storing data determined not to be stored in the first storage region in a second storage region which is different from the first storage region and is provided by the one or more nonvolatile semiconductor memory devices with the same characteristics.

13. A data management program executed by a computer included in a storage system capable of making connection to one or more nonvolatile semiconductor memory devices and capable of controlling inputting and outputting of data to and from a storage region of the nonvolatile semiconductor memory device, the data management program causing the computer:
to manage a part of a storage region provided by the one or more nonvolatile semiconductor memory devices with the same characteristics as a first storage region used to store predetermined data,
to determine data to be stored in the first storage region in data of which a write access frequency is less than a predetermined value, store the data in the first storage region, and
to store data determined not to be stored in the first storage region in a second storage region which is different from the first storage region and is provided by the one or more nonvolatile semiconductor memory devices with the same characteristics.
